(19) United States
(12) Patent Application Publication
(10) Pub. No.: US 2013/0221668 A1
(43) Pub. Date: Aug. 29, 2013

(54) MICRO COMBINED HEAT AND POWER UNIT

(71) Applicant: Jon Edward Butler, Oakdale, MN (US)

(72) Inventor: Jon Edward Butler, Oakdale, MN (US)

(21) Appl. No.: 13/566,879

(22) Filed: Aug. 3, 2012

Related U.S. Application Data
(60) Provisional application No. 61/634,329, filed on Feb. 27, 2012.

(51) Int. Cl. H02K 7/18; F24H 1/12

(52) U.S. Cl. 290/2; 137/340

(57) ABSTRACT

A unit for producing energy comprising an enclosed housing, a heat producing gas driven engine mounted within the housing, a rotatable device for producing electrical energy mounted within the housing and coupled to the engine for rotatably driving the device, the water-carrying piping coiled around the interior of the housing, the engine, the rotatable device and the piping immersed in oil within the housing, and including a means for circulating the oil in a prescribed path within the housing.

### CROSS REFERENCE TO RELATED APPLICATIONS

This application claims priority to currently pending U.S. Provisional Application Ser. No. 61/634,329 filed Feb. 27, 2012 titled Micro Combined Heat And Power Unit.

### FIELD OF THE INVENTION

This invention relates to providing a compact unit which produces electrical power and heating energy for single or multi family homes as well as small office buildings and the like. In particular the invention is commercially referred to as a micro combined heat and power unit, commonly referred to as MCHP.

### STATEMENT REGARDING FEDERALLY SPONSORED RESEARCH OR DEVELOPMENT

None

### REFERENCE TO A MICROFICHE APPENDIX

None

### DESCRIPTION OF PRIOR ART

Literature in the form of a technical specification of a hydronic system model HD-2200N by ECR International discloses a Honda MCHP unit and describes in some detail the function of this Honda unit and the function and the benefits of the MCHP system for providing power and heat energy.

### SUMMARY OF THE INVENTION

In the vast amount of instances, single and multiple family residences as well as relatively small office, medical and commercial buildings, and the like, require multiple forms of energy to provide heat and electricity for comfort and a variety of other uses. For the most part the energy would be obtained from large scale combined heat and power sources, sometimes referred to as cogeneration and identified as CHP generating sources and the energy transmitted over relatively long distances. More recently smaller or micro-sized combined heat and power CHP systems are being produced. In particular, smaller or micro-sized units, referred to as MCHP systems have become available. These provide particularly significant benefits for the smaller structures mentioned above because they are more efficient by utilizing the heat generated by the power generator instead of it becoming waste heat. The present invention provides a compact unit, which can be conveniently located at the site of any of the above mentioned structures to produce in an efficient and cost-effective manner the energy requirements for those structures thereby conserving energy and reducing carbon imprint by a significant amount. In addition, the units can be maintained by experienced tradesmen, such as electricians, plumbers, etc.

An embodiment of the invention comprises an enclosed housing containing a suitably mounted rotatable electrical power-generating device driven by an internal combustion gas driven engine, which preferably uses natural gas or propane. Also, water carrying piping or conduit is coiled around the interior of the housing and the interior is filled with lubricating oil so that the engine, the electrical power-generating device and the piping are immersed in the oil.

When the engine is operated it drives the electrical generating device and the oil circulates in a prearranged path over the heat producing engine, the electrical generating device and the coiled piping. This provides a continuous heat exchange system in which the circulating oil serves to cool the engine and transfer the heat to the coiled piping which heats the water carried by the piping. The hot water is tapped off and used for any purpose. A pumping mechanism may be included if necessary to ensure that the oil continues to circulate in a smooth continuous manner. Preferably the coiled piping has spaced outer fins for greater and more efficient heat exchange. The housing has suitably sealed couplings and/or connectors, as necessary, for any electrical, water, gas, or control connections into or out of the housing.

### BRIEF DESCRIPTION OF THE DRAWINGS

FIG. 1 is a schematic diagram showing an embodiment of a micro combined heat and power for producing energy;

FIG. 2 is a cross view of multi-chamber tubing assembly of FIG. 1 taken along the lines 2-2; and

FIG. 3 is a schematic diagram similar to FIG. 1 with a portion of the combined electric motor and generator broken away to show the heat-exchange piping.

### DESCRIPTION OF THE PREFERRED EMBODIMENT

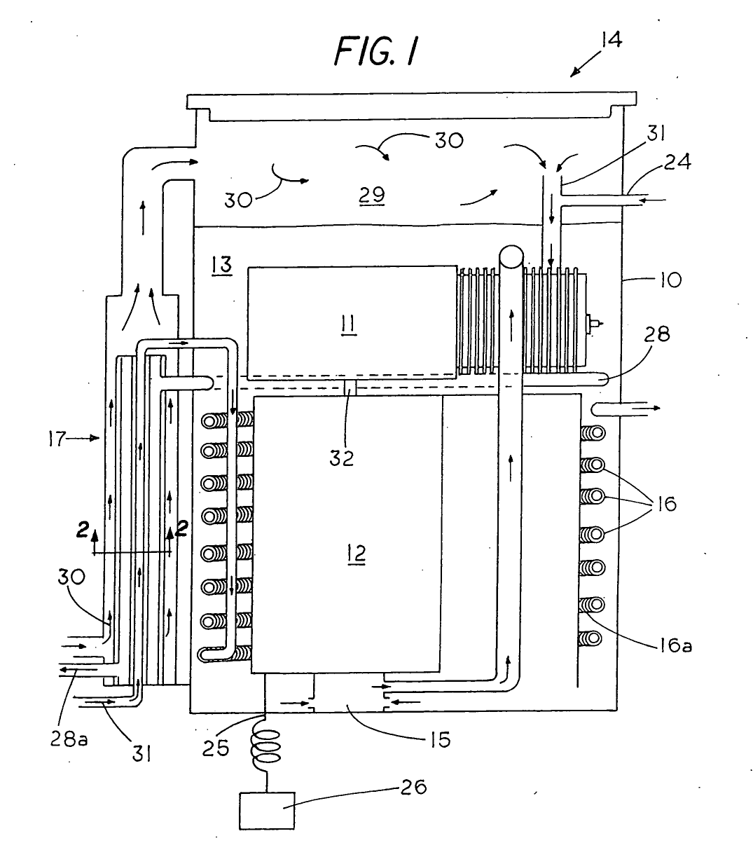

Referring to FIG. 1, FIG. 1 shows an embodiment of a system 14 of the present invention comprising an enclosed housing 10 having a heat producing gas driven internal combustion engine 11, which preferably uses natural gas or propane, mounted within housing 10. Enclosed housing 10 also includes a rotatable device such as a combined electric motor and generator 12 mounted within enclosed housing 10 and coupled to engine 11 by a shaft 32 for rotatably driving the combined electric motor and generator 12 at a speed for producing electrical energy.

Internal combustion engine 11 is connected to an outside fuel source (not shown), preferably a natural gas or propane fuel source, by gas inlet 24 to power the operation of internal combustion engine 11. Combined electric motor and generator 12 is preferably connected to an external power grid 26 by an electrical connector 25 such as a high voltage electrically insulated electrical wire line. The power grid may be used to supplement electrical power from another source or may be used to provide electrical power to other devices or may even feed back to an electrical power source or distributing system. Although power grid 26 is shown in FIG. 1 as being spaced from housing 10, alternative embodiment may comprise a power grid attached to but electrically insulated from housing 10.

A feature of the present invention is that engine 11 and combined electric motor and generator 12 are both submerged in a lubricating oil 13 within housing 10, the oil 13 having the dual purpose of cooling and lubricating the engine 11 and combined electric motor and generator 12. Because of the large volume of lubricating oil there likely will be no need to change engine oil for the life of the engine. Oil 13 may also provide access to the interior regions of engine 11 and combined electric motor and generator 12 for added cooling of their various parts.

System 14 may also include means for circulating oil 13 in a prescribed path within housing 10. For example system 14 is shown including a pumping mechanism 15 preferably located at the lower end of housing 10 for circulating the lubricating oil 13 from the bottom to the top of housing 10 to ensure that the lubricating oil 13 continues to circulate in a smooth continuous manner within housing 10.

Another feature of the present invention is that system 14 also includes heat-exchange piping 16 coiled around the interior of housing 10 for carrying a cool incoming fresh water flow 31 therein. Preferably heat-exchange piping 16 includes spaced-apart heat exchanger fins 16a shown located or mounted on the exterior of heat-exchange piping 16 to provide for increased heat exchange capabilities between the lubricating oil 13 and the water supported within heat-exchange piping 16. Spaced-apart heat exchanger fins 16a function to increase the surface area of the wall of heat-exchange piping 16 to increase the temperature conduction capabilities of the wall of heat-exchange piping 16. Increasing the temperature conduction capabilities of heat-exchange piping 16 increases the rate of temperature exchange between the lubricating oil 13 and the water supported within heat-exchange piping 16. Connecting heat-exchange piping 16 to a water source (not shown) is a multi-chamber tubing assembly 17.

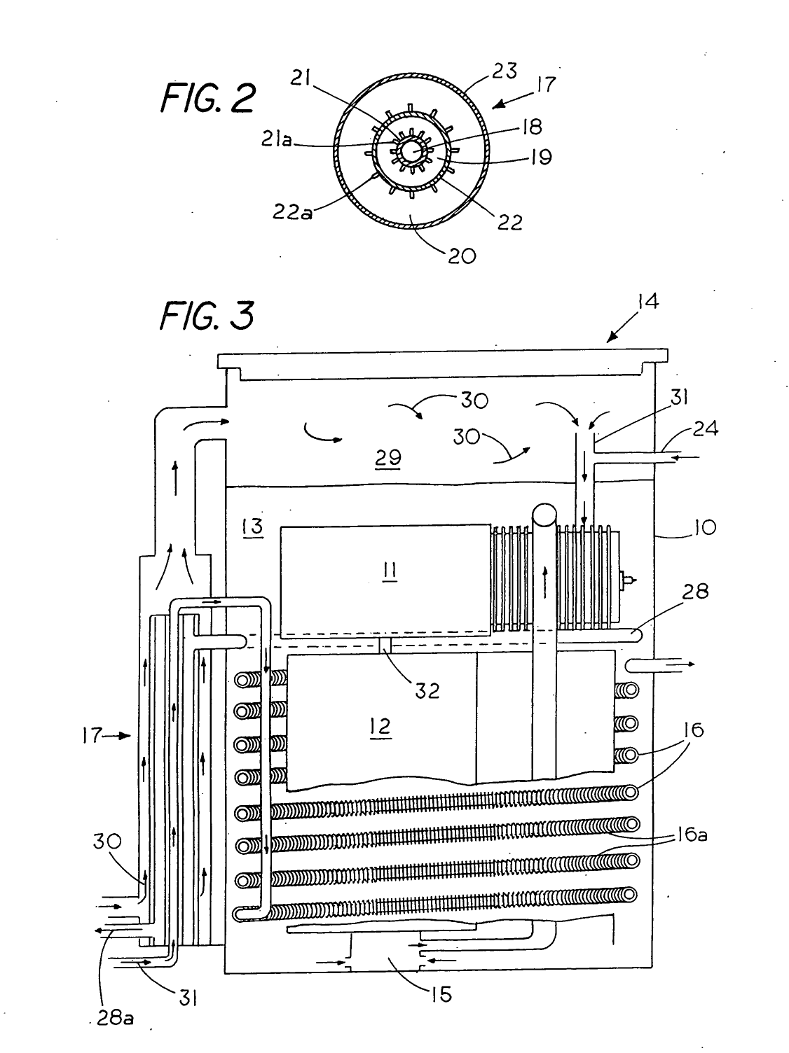

FIG. 2 is a cross-sectional view of the multi-chamber tubing assembly 17 of FIG. 1 taken along the lines 2-2. As shown in FIG. 2, multi-chamber tubing assembly 17 comprises an annular exhaust air chamber 19 sandwiched between a centrally located annular water chamber 18 and an intake air chamber 20. More specifically, centrally located annular water chamber 18 is separated with annular exhaust air chamber 19 by a first temperature conducting pipe wall 21. Intake air chamber 20 is separated with annular exhaust air chamber 19 by a second temperature conducting pipe wall 22 and is surrounded by an exterior pipe wall 23.

Centrally located cylindrical water chamber 18 is connected to a fresh water source such as city water supply or underground well water supply and functions to provide water flow from the fresh water source to heat-exchange piping 16. Intake air chamber 20 functions to support and deliver a fresh stream of air such as ambient air into system 14 while annular exhaust air chamber 19 functions to support and deliver air exhaust air, which is defined as ambient air that has been used in system 14, out of system 14.

First temperature conducting pipe wall 21 includes a plurality of fins 21a shown in FIG. 2 extending into annular exhaust air chamber 19 and second temperature conducting pipe wall 22 includes a plurality of fins 22a shown in FIG. 2 extending into annular intake air chamber 20. Fins 21a and 22a function to increase the surface area of temperature conducting pipe wall 21 and second temperature conducting pipe wall 22 to increase the temperature conduction capabilities of pipe walls 21 and 22. Increasing the temperature conduction capabilities of pipe walls 21 and 22 will allow for a faster and more efficient temperature exchange between the water supported in centrally located annular water chamber 18 and the exhaust air supported in chamber 19 and the temperature exchange between the exhaust air supported in chamber 19 and the fresh air supported by intake air chamber 20.

Although not shown, housing 10 has suitably sealed couplings and/or connectors, as necessary, for any electrical, water, gas, or control connections into or out of the housing 10.

In use of system 14, combined electric motor and generator 12 initiates the start of internal combustion engine 11. When internal combustion engine 11 is operated, internal combustion engine 11 rotatably drives the combined electric motor and generator 12 at a speed for producing electrical energy. The operation of internal combustion engine 11, combined electric motor and generator 12, and oil pump 15 causes the lubricating oil 13 to circulate in a prearranged path up and around engine 11 and the combined electric motor and generator 12 thereby heating the oil 13. The heated oil 13 then travels down and around the heat-exchange piping 16 and it's fins 16a to the bottom of the housing 10 and re-circulate in the same path.

As the heated oil 13 engages the spaced-apart heat exchanger fins 16a and the wall of heat-exchange piping 16 the oil 13 and the water supported within heat-exchange piping 16 forms a symbiotic relationship in which the oil 13 raises the temperature of water carried within heat-exchange piping 16 while the water within heat-exchange piping 16 in turn cools down the temperature of oil 13. This allows the oil to recirculate to continue its lubricating and cooling function yet prevents it from overheating.

Exhaust gasses 28a originating from internal combustion engine 11 passes through an exhaust gas finned tubing 28 located in the oil 13 directly above the heat-exchange piping 16 so the hot oil passes over exhaust gas finned tubing 28 before the heated oil 13 engages the heat-exchange piping 16.

The exhaust gasses 28a then travels through a final heat exchange comprising multi-chamber tubing assembly 17, which is shown in the embodiment of FIGS. 1 and 3 mounted on the exterior of housing 10. Multi-chamber tubing assembly 17 is designed to absorb the maximum amount of heat from exhaust gasses 28a by using the cool incoming water flow 31 and the fresh ambient air 30 through the temperature exchange between the cool incoming water flow supported in centrally located annular water chamber 18 and exhaust gasses 28a and by the temperature exchange between exhaust gasses 28a and the fresh ambient air 30 supported by intake air chamber 20.

The fresh ambient air 30, which is also referred to as the combustion air, after being preheated by the exhaust gasses 28a, travels up and into a free space 29 located proximal the top portion of housing 10.

While in free space 29, ambient air 30 absorbs oil fumes and then travels into an air intake 31 where a fuel source such as natural gas or propane's delivered by gas inlet 24 and is injected into the stream ambient air 30 and eventually delivered to engine 11.

The cool incoming water flow 31 is directed through multi-chamber tubing assembly 17 and then through heat-exchange piping 16 and eventually then out of housing 10 as heated water to a hot water reservoir.

Generally speaking, this provides a continuous heat exchange system in which the circulating lubricating oil 13 serves to cool the internal combustion engine 11 and combined electric motor and generator 12 and transfer the heat generated by the internal combustion engine 11 and the combined electric motor and generator 12 to the coiled heat-exchange piping 16 which heats the water carried therein. The hot water is then delivered out of system 14 into a water reservoir such as the holding tank (not shown) and used for any hot water applications including but not limited to radiant heating, bathing, and other household or commercial needs.

Although not shown, housing 10 has suitably sealed couplings and/or connectors, as necessary, for any electrical, water, gas, or control connections into or out of the housing 10.

An example of a working model of the present invention would comprise system 14 preferably is mounted outside the home and enclosed in an insulated cover, for added home safety and easy access for maintenance.

Located inside a home or a building would be an electric hot water heater and/or hot water baseboard radiators connected to system 14. Heated water is stored in a water heater until needed for heat or hot water. Control unit for system would be installed inside the home and would monitor voltage in power grid, water temp, outside temp, thermostat settings and all heat and pressure sensors on system 14.

I claim:

1. A unit for producing energy, comprising:
an enclosed housing;
a heat producing gas driven engine mounted within said housing;
a rotatable device for producing electrical energy mounted within said housing and coupled to said engine for rotatably driving said device;
water-carrying piping coiled around the interior of said housing;
said engine, said rotatable device and said piping immersed in oil within said housing; and
means for circulating said oil in a prescribed path within said housing.

2. An energy-producing unit as described in claim 1 wherein said rotatable device is an electric motor driven by said engine at a speed to produce electrical energy.

3. An energy-producing unit as described in claim 1 wherein said means for circulating said oil includes a pumping device.

4. An energy-producing unit as described in claim 1 further including a plurality of spaced-apart heat exchanger fins mounted on the exterior of said piping.

5. An energy-producing unit as described in claim 1, further including:
a) a water connector mounted on said housing coupled to said piping;
b) an electrical connector mounted on said housing coupled to said electric motor; and
c) a gas connector mounted on said housing coupled to said engine.

6. An energy-producing unit as described in claim 1 wherein said engine, said rotatable device and said piping are in heat exchanging relationship with said oil.

7. A dual purpose, electrical energy and hot water producing system comprising:
an enclosed housing;
a heat producing gas driven engine supported within said housing;
an electrical energy producing device supported within said housing, said electrical energy producing device connected to said engine for driving said device;
a heat-exchange piping coiled around the interior of said housing, said heat-exchange piping containing a water stream therein;
said engine, said electrical energy producing device and said piping submerged in oil within said housing, said oil transferring heat generated by the operation of said engine and said electrical energy producing device to said water stream and vice versa; and
means for circulating said oil in a prescribed path within said housing.

8. The system of claim 7 wherein the electrical energy-producing device comprises a rotatable device.

9. The system of claim 8 wherein the rotatable device comprises an electric motor driven by said engine at a speed to produce electrical energy.

10. The system of claim 9 wherein said means for circulating said oil includes a pumping device.

11. The system of claim 10 wherein said heat-exchange piping includes a plurality of spaced-apart heat exchanger fins mounted on the exterior of said piping.

12. The system of claim 11 including a multi-chamber tubing assembly comprising a first sidewall forming a cylindrical water chamber, a second sidewall surrounding said first side wall to form an annular exhaust air chamber, and a third side wall surround said second side wall forming an annular intake air chamber, said cylindrical water chamber coupling said heat-exchange piping to a fresh water source, said annular exhaust air chamber venting said engine into said environment, and said annular intake air chamber providing said engine with a source of combustion air.

13. The system of claim 12 wherein said first sidewall and said second sidewall of said multi-chamber tubing assembly each includes a plurality of fins extending therefrom.

14. The system of claim 13 further including:
an electrical connector mounted on said housing coupled to said electric motor; and
a gas inlet mounted on said housing coupled to said engine.

15. A dual purpose, electrical energy and hot water producing system comprising:
an enclosed housing;
a heat producing gas driven engine supported within said housing;
an electrical energy producing rotatable device supported within said housing, said rotatable device connected to said engine for driving said rotatable device;
heat-exchange piping coiled around the interior of said housing, said heat-exchange piping containing a water stream therein;
said engine, said rotatable device and said piping submerged in oil within said housing, said oil transferring heat generated by the operation of said engine and said rotatable device to said pipe;
a multi-chamber tubing assembly comprising a first sidewall forming a cylindrical water chamber, a second sidewall surrounding said first side wall to form an annular exhaust air chamber, and a third side wall surround said second side wall forming an annular intake air chamber, said cylindrical water chamber coupling said heat-exchange piping to a fresh water source, said annular exhaust air chamber venting said engine into said environment, and said annular intake air chamber providing said engine with a source of combustion air; and
means for circulating said oil in a prescribed path within said housing.

16. The system of claim 15 wherein said means for circulating said oil includes a pumping device.

17. The system of claim 15 wherein said heat-exchange piping includes a plurality of spaced-apart heat exchanger fins mounted on the exterior of said piping.

19. The system of claim 15 wherein said first sidewall and said second sidewall of said multi-chamber tubing assembly each includes a plurality of fins extending therefrom.

20. The system of claim 19 further including:
an electrical connector mounted on said housing coupled to said electric motor; and
a gas inlet mounted on said housing coupled to said engine.
